(19) United States
(12) Patent Application Publication
(10) Pub. No.: US 2026/0356239 A1
(43) Pub. Date: Nov. 12, 2026

(54) BATTERY ASSEMBLY AND SNOW-CLEARING ROBOT

(71) Applicant: SHENZHEN HANYANG TECHNOLOGY CO., LTD., Shenzhen (CN)

(72) Inventors: Yongqi SONG, Shenzhen (CN); Taotao ZHU, Shenzhen (CN)

(21) Appl. No.: 19/701,534

(22) Filed: Jun. 8, 2026

Related U.S. Application Data
(63) Continuation of application No. PCT/CN2023/132675, filed on Nov. 20, 2023.

(30) Foreign Application Priority Data
Sep. 7, 2023 (CN) 202322439021.0
Sep. 7, 2023 (CN) 202322449202.1
Sep. 7, 2023 (CN) 202322450162.2

(51) Int. Cl. B60L 53/80; B60L 50/64; E01H 5/04; H01M 50/50; H01R 12/71

(52) U.S. Cl. CPC B60L 53/80; B60L 50/64; H01M 50/50; B60L 2200/40; E01H 5/04; H01M 2220/20; H01R 12/716

(57) ABSTRACT

The present disclosure relates to a battery assembly and a snow-clearing robot. The battery assembly may include a battery and a battery compartment. The battery may include a battery cell body and a female connector, the female connector may be disposed at a top edge of the battery cell body or adjacent to the battery cell body, a bottom portion of the female connector may be exposed from the battery cell body, and the female connector may serve as both a charging interface and a discharging interface for the battery cell body; the battery compartment may have a tubular shape, the battery may be removably inserted into the battery compartment; the battery compartment may be provided with a male connector configured to mate with the female connector, and when the battery is installed in the battery compartment, the male connector may engage with the female connector.

### CROSS-REFERENCE TO RELATED APPLICATIONS

This patent document claims priority to and the benefits of PCT Application No. PCT/CN2023/132675 filed on Nov. 20, 2023, which further claims priority to and the benefits of Chinese Patent Application Nos. 202322450162.2, 202322449202.1, and 202322439021.0 all filed on Sep. 7, 2023, the contents of each of which are hereby incorporated by reference.

### TECHNICAL FIELD

The present disclosure relates to the field of robot technology, and particularly relates to a battery assembly and a snow-clearing robot.

### BACKGROUND

With the rapid development of robot technology, household robots have proliferated into every corner of daily life. As one type of household robot, a snow-clearing robot includes a snow-clearing device and a carrier configured to move the snow-clearing device around a yard. The carrier may be a wheeled or tracked vehicle body, and the snow-clearing device generally includes a snow-rolling mechanism and a snow-throwing mechanism. The snow-rolling mechanism gathers snow from the ground into a snow-rolling chamber, and the snow-throwing mechanism then throws the accumulated snow from the snow-rolling chamber in a designated direction.

In pursuit of low-carbon, environmental protection, energy conservation, and emission reduction goals, traditional snow-clearing robots powered by fuel are gradually being phased out. The current development trend for snow-clearing robots is to predominantly utilize an electric structure powered by a storage battery. A common storage battery configuration currently available on the market involves removing the storage battery from the main unit of the snow-clearing robot and connecting the storage battery to a separate charging base via its charging interface for recharging. After the storage battery is reinstalled in the main unit of the snow-clearing robot, a separate power cord is used to connect a discharging interface of the storage battery to the snow-clearing robot to enable discharging.

### SUMMARY

According to various embodiments of the present disclosure, a battery assembly and a snow-clearing robot are provided.

The battery assembly according to some embodiments of the present disclosure includes: a battery, including a battery cell body and a female connector, wherein the female connector is disposed at a top edge of the battery cell body or adjacent to the battery cell body, a bottom portion of the female connector is exposed from the battery cell body, and the female connector is configured to serve as both a charging interface and a discharging interface for the battery cell body; and a battery compartment having a tubular shape, wherein the battery is configured to be removably inserted into the battery compartment, the battery compartment is provided with a male connector configured to mate with the female connector, and when the battery is installed in the battery compartment, the male connector is configured to engage with the female connector.

In some embodiments, a female connector protective cover is disposed around a periphery of the female connector, the female connector protective cover has a generally plate-shaped structure and defines a female connector fixing cavity extending therethrough in a vertical direction, and the female connector is configured to be inserted into the female connector fixing cavity; and a bottom surface of the female connector is flush with, or slightly above, a lower edge of an inner surface of the female connector fixing cavity.

In some embodiments, a plurality of connecting tabs are disposed circumferentially along an edge of the female connector protective cover.

In some embodiments, a top protective cover is disposed at a top portion of the battery cell body, the top protective cover is detachably connected to the battery cell body, the top protective cover is configured to cover top portions of the female connector and the female connector protective cover, and the female connector protective cover is detachably connected to the top protective cover via the plurality of connecting tabs.

In some embodiments, a female connector circuit board is disposed between the top protective cover and the female connector, and the female connector is fixed below the female connector circuit board and is electrically coupled to the female connector circuit board.

In some embodiments, a top portion of the top protective cover defines a first groove recessed downward, and a handle is disposed on the top protective cover, the handle spanning two ends of the first groove.

In some embodiments, a space between a sidewall defining the first groove and a sidewall of the top protective cover forms an installation cavity, and the female connector circuit board is disposed within the installation cavity.

In some embodiments, a side of the female connector protective cover is exposed at a side surface of the battery cell body.

In some embodiments, a slide groove is formed along the vertical direction on a side of the battery cell body where the female connector protective cover is disposed, and the battery cell body is configured to slide up and down in the vertical direction relative to the male connector via the slide groove.

In some embodiments, a bottom protective cover is disposed at a bottom portion of the battery cell body, and the battery cell body is detachably connected to the bottom protective cover.

In some embodiments, the battery includes a top protective cover disposed at a top portion of the battery cell body and detachably connected to the battery cell body, and the top protective cover is configured to cover a top portion of the female connector.

In some embodiments, a plurality of first through holes are disposed circumferentially in a top portion of the top protective cover, a first connecting bolt is disposed through each of the plurality of first through holes, a plurality of first connecting holes are disposed in the top portion of the battery cell body, the plurality of first connecting holes corresponding respectively to the plurality of first through holes, and each first connecting bolt is configured to pass through a corresponding one of the plurality of first connecting holes and to engage with a nut, such that the top protective cover is secured relative to the battery cell body.

In some embodiments, the battery compartment includes a base, a front plate, a rear plate, a left plate, and a right plate, each of the front plate, the rear plate, the left plate, and the right plate is perpendicular to the base, and the front plate, the rear plate, the left plate, and the right plate collectively define an accommodating cavity shaped to receive the battery.

In some embodiments, the rear plate, the left plate, and the right plate are integrally formed, and the front plate is detachably connected to the left plate and the right plate; a second through hole is provided at each of two sides of the front plate, and a second connecting bolt is disposed through each of the plurality of second through holes; a connecting plate is provided at an edge of each of the left plate and the right plate adjacent to the front plate, the connecting plate is parallel to the front plate, and a second connecting hole is provided in each connecting plate, the second connecting hole corresponding to a respective one of the plurality of second through holes; and each of the plurality of second connecting bolts is configured to pass through the corresponding second connecting hole and to engage with a nut, such that the front plate is secured to the left plate and to the right plate.

In some embodiments, protruding positioning blocks are disposed at bottom portions of the left plate and the right plate, the base is provided with positioning holes configured to receive the positioning blocks, and the positioning blocks are configured to be inserted into the positioning holes.

In some embodiments, fixing tabs are respectively disposed at the bottom portions of the left plate and the right plate, the fixing tabs being perpendicular to the positioning blocks and extending away from the battery compartment; a third through hole is provided in each of the fixing tabs, and a third connecting bolt is disposed through each of the plurality of third through holes; a plurality of third connecting holes corresponding to the plurality of third through holes are disposed in the base; and each of the plurality of third connecting bolts is configured to pass through a corresponding one of the plurality of third connecting holes and to engage with a nut, such that the fixing tabs are secured to the base.

In some embodiments, upper portions of the rear plate, the left plate, and the right plate are inclined outwardly to form expanded portions, and the expanded portions collectively define a tapered structure that is wider at a top and narrower at a bottom.

In some embodiments, a top portion of the top protective cover defines a first groove recessed downward, and a handle is disposed on the top protective cover, the handle spanning two ends of the first groove.

In some embodiments, a female connector protective cover is disposed around a periphery of the female connector, one side of the female connector protective cover is exposed at a side surface of the battery cell body, and the side of the female connector protective cover is flush with a sidewall of the top protective cover at the side surface.

In some embodiments, a connecting bracket is disposed at a top portion of the battery compartment, a bracket base is fixedly connected to the connecting bracket, and the male connector is disposed on the bracket base.

In some embodiments, the connecting bracket has an inverted L-shape and includes a vertical bracket sidewall and a horizontal bracket sidewall, and a bracket through hole is provided in the horizontal bracket sidewall and is configured to receive the bracket base.

In some embodiments, the bracket base has a generally L-shape and includes a vertical support sidewall and a horizontal support sidewall, the vertical support sidewall is parallel to the vertical bracket sidewall, the horizontal support sidewall is parallel to the horizontal bracket sidewall, and the male connector is detachably connected to the vertical support sidewall; the horizontal support sidewall is positioned above the horizontal bracket sidewall, and a support connecting hole is provided at a bottom portion of the horizontal support sidewall, the support connecting hole corresponding to the bracket through hole; and a vertical support post is disposed within the battery compartment, a connecting post is disposed at a top portion of the vertical support post, and the connecting post is configured to extend through the bracket through hole and to threadedly engage the horizontal support sidewall at the support connecting hole, such that the bracket base is secured to the vertical support post.

In some embodiments, the battery compartment includes a base, a front plate, a rear plate, a left plate, and a right plate, each of the front plate, the rear plate, the left plate, and the right plate is perpendicular to the base, and the front plate, the rear plate, the left plate, and the right plate collectively define an accommodating cavity shaped to receive the battery.

In some embodiments, the connecting bracket is disposed on the left plate, the vertical bracket sidewall is integrally connected to the left plate, and the horizontal bracket sidewall is perpendicular to the left plate and extends toward the right plate.

In some embodiments, at least two vertical support posts are provided, and a bottom portion of each of the at least two vertical support posts is detachably connected to the base.

In some embodiments, upper portions of the rear plate, the left plate, and the right plate are inclined outwardly to form expanded portions, and a clearance hole is provided in the expanded portion of the left plate.

In some embodiments, a slide groove is formed along the vertical direction on a side of the battery cell body adjacent to the female connector, and the battery cell body is configured to slide up and down in the vertical direction relative to the male connector via the slide groove.

In some embodiments, the battery includes a top protective cover disposed at a top portion of the battery cell body and a bottom protective cover disposed at a bottom portion of the battery cell body, the top protective cover is detachably connected to the battery cell body, and the bottom protective cover is detachably connected to the battery cell body.

The snow-clearing robot according to some embodiments of the present disclosure includes the aforementioned battery assembly.

Details of one or more embodiments of the present disclosure are set forth in the following drawings and description. Other features, objects, and advantages of the present disclosure will become apparent from the descriptions, the drawings, and the claims.

### BRIEF DESCRIPTION OF THE DRAWINGS

To better describe and illustrate the embodiments and/or examples disclosed herein, reference may be made to one or more drawings. Additional details or examples used to describe the drawings should not be construed as limitations on the scope of the embodiments and/or examples of the present disclosure.

FIG. 1 is an exemplary schematic structural diagram of a battery assembly according to some embodiments of the present disclosure;

FIG. 2 is an exploded schematic diagram of the battery assembly shown in FIG. 1;

FIG. 3 is a cross-sectional schematic diagram of the battery assembly shown in FIG. 1;

FIG. 4 is an enlarged partial view of region B in FIG. 3;

FIG. 5 is a schematic diagram of a battery in the battery assembly shown in FIG. 1;

FIG. 6 is an exploded schematic diagram of a battery compartment in the battery assembly shown in FIG. 1;

FIG. 7 is an enlarged partial view of region A in FIG. 6;

FIG. 8 is a schematic diagram of a male connector and a bracket base in the battery assembly shown in FIG. 1; and

FIG. 9 is a schematic structural diagram of a female connector protective cover in the battery assembly shown in FIG. 1.

### DETAILED DESCRIPTION

To make the above-mentioned objectives, features, and advantages of the present technology more clearly and easily understandable, detailed descriptions of the specific implementation of the present technology are provided below in conjunction with the accompanying drawings. While many specific details are described to facilitate a complete understanding of the present technology, it should be understood that the present technology may be implemented in various ways beyond those described herein. Those skilled in the art can make modifications and improvements without departing from the scope of the present disclosure. Accordingly, the present disclosure is not limited to the embodiments disclosed below.

In the description of the present disclosure, it should be understood that the orientation or positional relationships indicated by terms such as “center,” “vertical,” “horizontal,” “length,” “width,” “thickness,” “upper,” “lower,” “front,” “rear,” “left,” “right,” “vertical,” “horizontal,” “top,” “bottom,” “inner,” “outer,” “clockwise,” “counterclockwise,” “axial,” “radial,” and “circumferential” are based on the orientation or positional relationships shown in the drawings. These are merely for the convenience of describing the present technology and simplifying the description, and do not indicate or imply that the device or element must have a specific orientation, or be constructed and operated in a specific orientation. Therefore, they should not be construed as limitations on the present disclosure.

In the present disclosure, unless otherwise expressly specified and limited, a first feature being “on” or “under” a second feature may mean that the first and second features are in direct contact, or that the first and second features are in indirect contact through an intermediate medium. Furthermore, a first feature being “above,” “over,” and “on top of” a second feature may mean that the first feature is directly above or obliquely above the second feature, or may merely mean that the horizontal height of the first feature is greater than that of the second feature. A first feature being “under,” “below,” and “beneath” a second feature may mean that the first feature is directly below or obliquely below the second feature, or may merely mean that the horizontal height of the first feature is less than that of the second feature. The terms “vertical,” “horizontal,” “upper,” “lower,” “left,” “right,” and similar expressions used in the present disclosure are for descriptive purposes only and do not represent the only implementation mode.

Furthermore, the terms “first” and “second” are used for descriptive purposes only and should not be construed as indicating or implying relative importance or implicitly specifying the number of the indicated technical features. Thus, features defined by “first” and “second” may explicitly or implicitly include at least one of the features. In the description of the present disclosure, the meaning of “a plurality of” is at least two, for example, two, three, etc., unless otherwise expressly and specifically limited.

In the present disclosure, unless otherwise expressly specified and limited, terms such as “installed,” “connected,” “connection,” and “fixed” should be broadly understood. For example, such terms may refer to a fixed connection, a detachable connection, or an integral connection; they may refer to a mechanical connection or an electrical connection; they may refer to a direct connection or an indirect connection through an intermediate medium; they may refer to internal communication between two components or an interaction relationship between two components, unless otherwise expressly limited. It should be noted that when a component is described as being “fixed to” or “disposed on” another component, it can be directly on the other component or there may be an intervening component. When a component is considered to be “connected” to another component, it can be directly connected to the other component or there may be an intervening component at the same time. For those of ordinary skill in the art, the specific meaning of the above-mentioned terms in the present disclosure can be understood according to the specific situation.

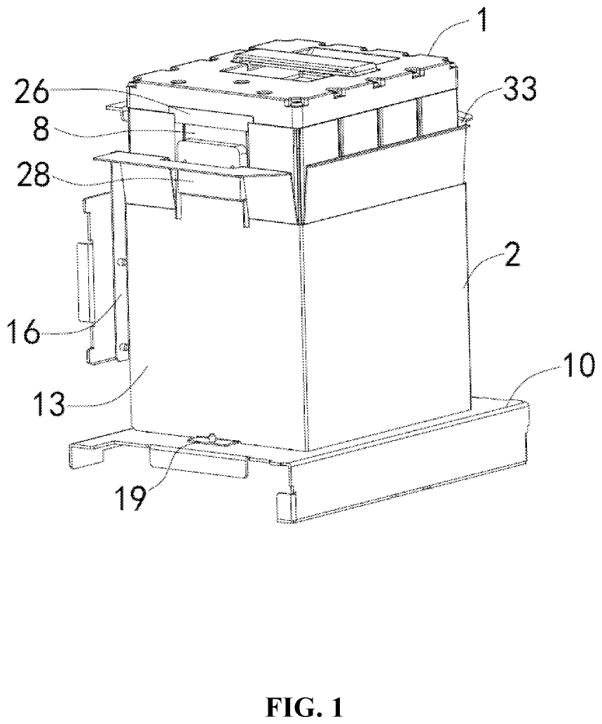

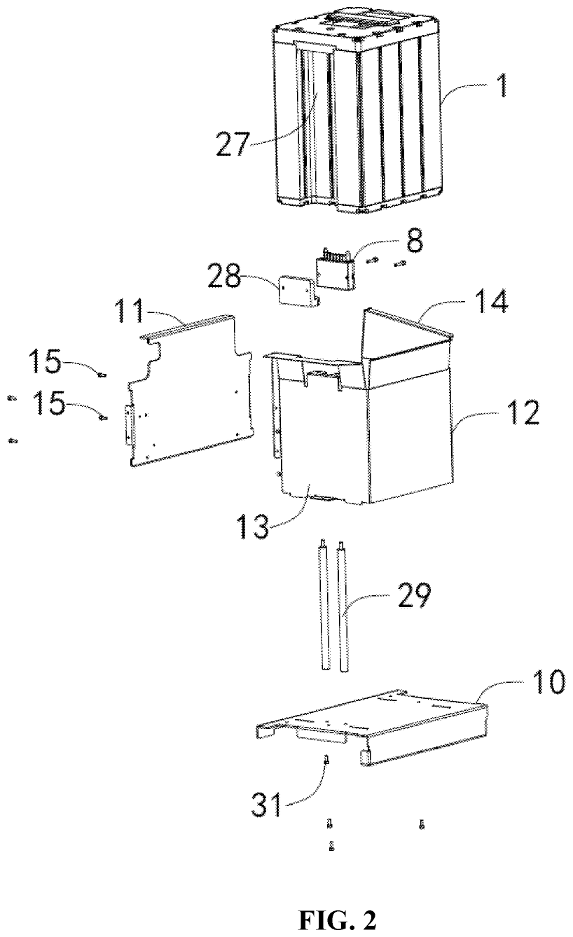

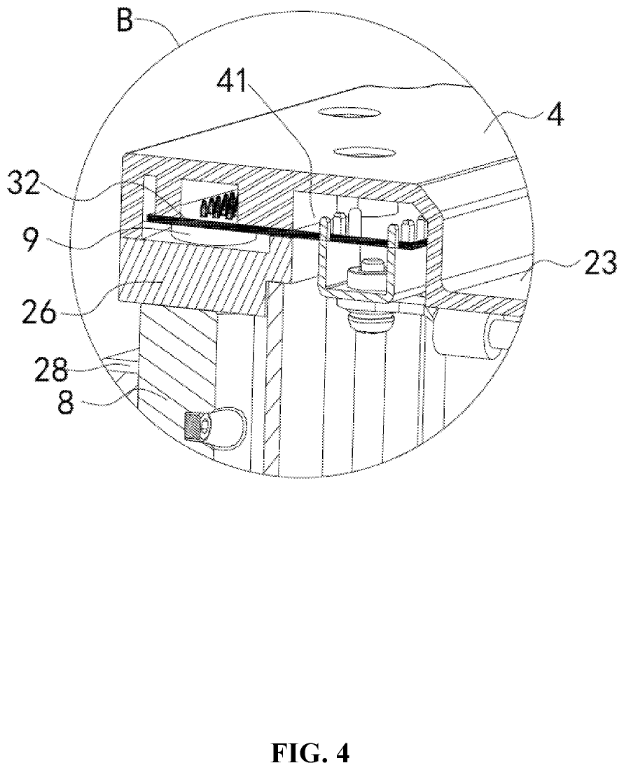

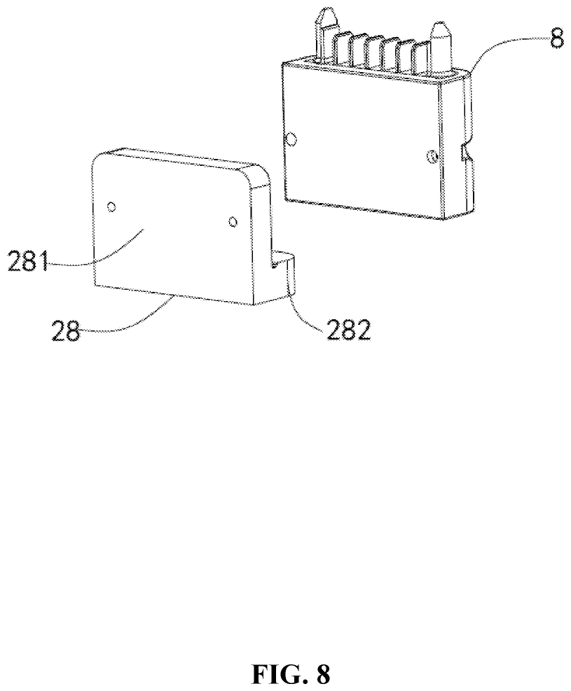

As shown in FIGS. 1 to 9, the present disclosure provides a battery assembly. The battery assembly may include a battery 1 and a battery compartment 2. The battery 1 may be quickly installed in or removed from the battery compartment 2. When inserted in the battery compartment 2, the battery 1 may supply power to an external device (for example, a main unit of a snow-clearing robot) through the battery compartment 2. When the battery 1 is low on power, the battery 1 may be removed from the battery compartment 2 for charging, and after charging is completed, the battery 1 may be put back into the battery compartment 2 to continue supplying power.

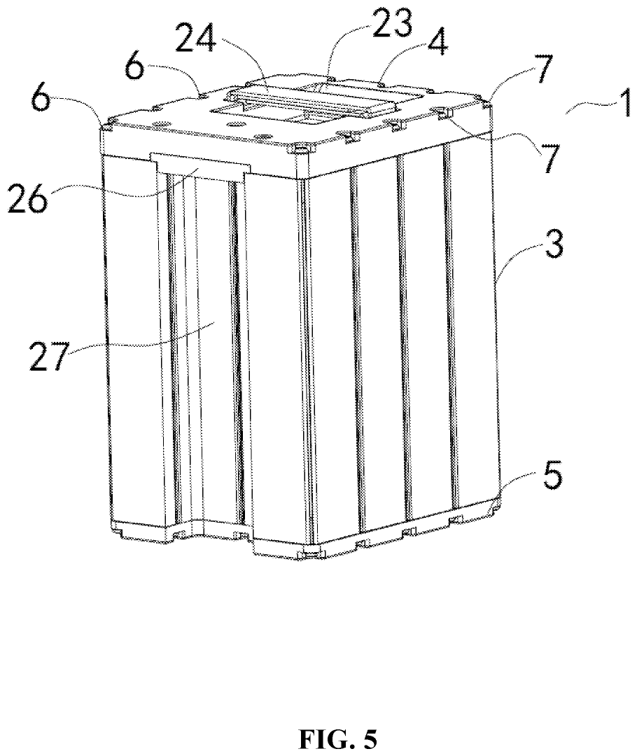

As shown in FIGS. 1 and 5, in some embodiments, the battery 1 may include a battery cell body 3, a top protective cover 4, and a bottom protective cover 5. The top protective cover 4 may be disposed at a top portion of the battery cell body 3. The top protective cover 4 may be detachably connected to the battery cell body 3. A plurality of first through holes 6 may be arranged circumferentially in the top portion of the top protective cover 4. A first connecting bolt 7 may be disposed through each of the plurality of first through holes 6. A plurality of first connecting holes (not shown) may be disposed in the top portion of the battery cell body 3. The plurality of first connecting holes may correspond respectively to the plurality of first through holes 6. Each first connecting bolt 7 may be configured to pass through a corresponding one of the plurality of first connecting holes and to engage with a nut, such that the top protective cover 4 may be secured to the battery cell body 3. In this way, the detachable connection between the top protective cover 4 and the battery cell body 3 may be achieved. Similar to the top protective cover 4, the bottom protective cover 5 may be detachably connected to the battery cell body 3 in this manner, which will not be repeated here.

As shown in FIG. 5, in some embodiments, the top portion of the top protective cover 4 may define a first groove 23 recessed downward. The top protective cover 4 may be provided with a handle 24. The handle 24 may span two ends of the first groove 23. By providing the first groove 23, it may be convenient for a hand to grip the handle 24. The battery 1 may be pulled out from or pushed in the battery compartment 2 via the handle 24, making it convenient to remove the battery 1 from or install the battery 1 in the battery compartment 2.

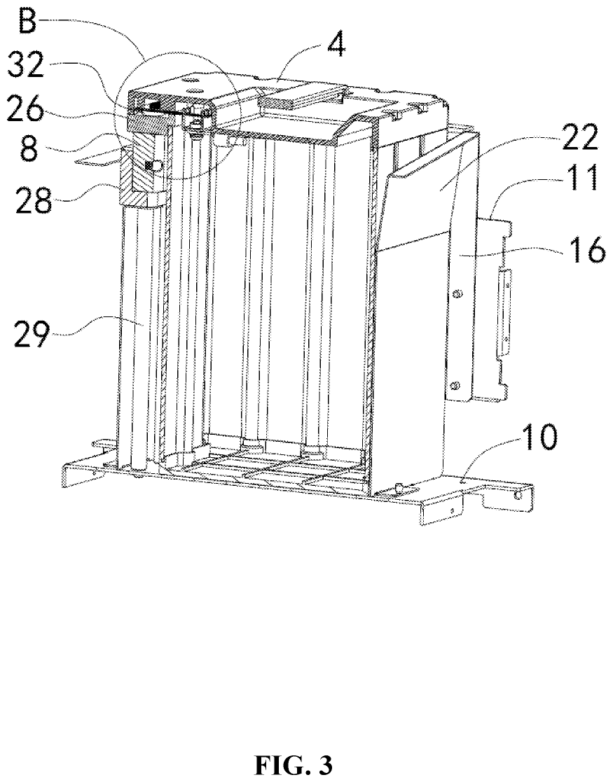

As shown in FIGS. 3, 4, and 9, in some embodiments, a female connector 9 may be disposed at a top edge of the battery cell body 3 or adjacent to the battery cell body 3. A bottom portion of the female connector 9 may be exposed from the battery cell body 3. The female connector 9 may be configured to serve as both a charging interface and a discharging interface for the battery cell body 3. The battery compartment 2 may have a generally tubular shape adapted to the battery 1. The battery 1 may be configured to be removably inserted into the battery compartment 2. The battery compartment 2 may be provided with a male connector 8 configured to mate with the female connector 9. When the battery 1 is installed in the battery compartment 2, the male connector 8 may engage with the female connector 9.

The battery 1 may be generally rectangular. In some embodiments, the shape of the battery 1 may be varied.

In some embodiments, the positions of the female connector 9 and the male connector 8 may be interchanged, that is, the male connector 8 may be disposed on the battery cell body 3, and the female connector 9 may be disposed in the battery compartment 2.

When removed from the battery compartment 2, the battery 1 may be charged via the female connector 9. After the battery 1 is fully charged, it may be put back into the battery compartment 2, the female connector 9 may engage with the male connector 8, and the female connector 9 may serve as the discharging interface to discharge via the battery compartment 2. It can be seen that the female connector 9 may serve as both the charging interface and the discharging interface, so the charging interface and the discharging interface may be integrated in the battery 1, and the user may not need to distinguish between them during use, which may simplify operation.

In addition, when installed in the battery compartment 2, the battery 1 may be connected to the battery compartment 2 without using an additional power cord, but directly through the engagement of the female connector 9 and the male connector 8, thereby reducing circuit damage caused by the user during installation and removal of the battery 1, extending the service life of the battery, and achieving quick disassembly and assembly of the battery assembly.

It can be understood that in conventional storage battery design, the charging interface and the discharging interface of the storage battery may be independent of each other and may be located at different positions, which may increase the manufacturing cost of the storage battery and may increase the difficulty for the user to install the storage battery. The battery assembly of the present disclosure can solve this problem, reducing the manufacturing cost of the battery 1 and making the operation of installing the battery 1 by the user simple and convenient.

Furthermore, the male connector 8 may be disposed at a top portion of the battery compartment 2, and the female connector 9 may be disposed at a top portion of the battery 1. After the male connector 8 and the female connector 9 are engaged, they may be located at a relatively high vertical position, and snow water may not enter the male connector 8 and the female connector 9, thereby avoiding damage to the battery assembly, so that the battery assembly has a waterproof function.

In some embodiments, a female connector circuit board 32 may be disposed between the top protective cover 4 and the female connector 9. The female connector 9 may be fixed below the female connector circuit board 32 and may be electrically coupled to the female connector circuit board 32.

Specifically, a space between a sidewall defining the first groove 23 and a sidewall of the top protective cover 4 may form an installation cavity 41. The female connector circuit board 32 may be disposed within the installation cavity 41 and may be electrically coupled to the battery cell body 3.

A female connector protective cover 26 may be disposed around a periphery of the female connector 9. The female connector protective cover 26 may play a protective role on the female connector 9 to prevent snow water, sand, dust, etc. from entering the female connector 9 and causing the female connector 9 to be damaged or fail.

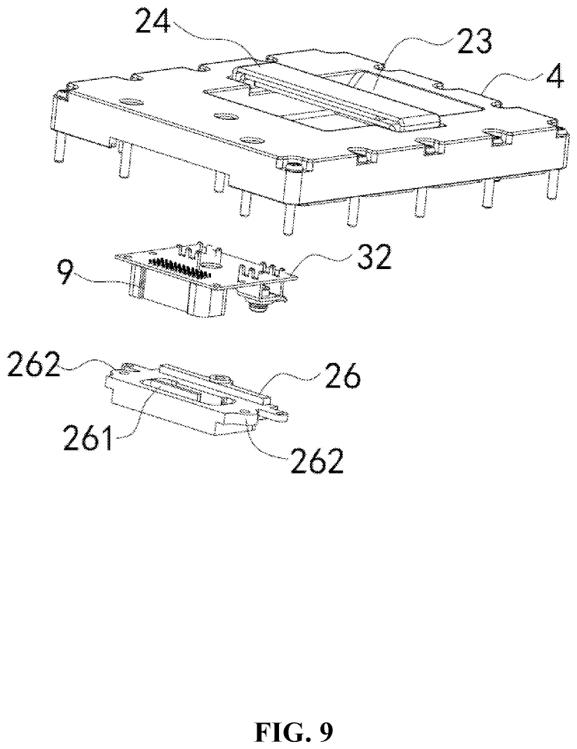

As shown in FIG. 9, in some embodiments, the female connector protective cover 26 may have a generally plate-shaped structure. The female connector protective cover 26 may define a female connector fixing cavity 261 extending therethrough in the vertical direction. The female connector 9 may be configured to be inserted into the female connector fixing cavity 261. A bottom surface of the female connector 9 may be flush with a lower edge of an inner surface of the female connector fixing cavity 261 to facilitate engagement with the male connector 8 in the battery compartment 2. In some embodiments, the bottom surface of the female connector 9 may be slightly above the lower edge of the inner surface of the female connector fixing cavity 261, so that the bottom portion of the female connector 9 is not exposed, which may provide a protective effect on the bottom portion of the female connector 9.

Thus, the battery assembly of some embodiments may include a battery 1 and a battery compartment 2. The battery 1 may include a battery cell body 3 and a female connector 9. The female connector 9 may be disposed at the top edge of the battery cell body 3 or adjacent to the battery cell body 3. The bottom portion of the female connector 9 may be exposed from the battery cell body 3. The female connector protective cover 26 may be disposed around the periphery of the female connector 9. The female connector protective cover 26 may define a female connector fixing cavity 261. The female connector 9 may be configured to be inserted into the female connector fixing cavity 261. The bottom surface of the female connector 9 may be flush with or may be slightly above the lower edge of the inner surface of the female connector fixing cavity 261. The battery 1 may be configured to be inserted into the battery compartment 2. The male connector 8 configured to mate with the female connector 9 may be disposed in the battery compartment 2. When the battery 1 is installed in the battery compartment 2, the male connector 8 may engage with the female connector 9. The female connector protective cover 26 may play a protective role on the female connector 9 to prevent snow water, sand, dust, etc. from entering the female connector 9 and causing the female connector 9 to be damaged or fail, so that the battery assembly has an interface protection function.

In some embodiments, the top protective cover 4 may be disposed at the top portion of the battery cell body 3. The top protective cover 4 may be detachably connected to the battery cell body 3. The top protective cover 4 may be configured to cover the top portion of the female connector 9. In this way, the top portion of the female connector 9 may be enclosed within the top protective cover 4, so that the top protective cover 4 can provide a protective effect on the top portion of the female connector 9.

Specifically, the top protective cover 4 may cover top portions of the female connector 9 and the female connector protective cover 26, that is, the top portions of the female connector 9 and the female connector protective cover 26 may be both enclosed within the top protective cover 4, so that the top protective cover 4 can provide a protective effect on both the top portion of the female connector 9 and the female connector protective cover 26.

In some embodiments, a plurality of connecting tabs 262 may be disposed circumferentially along an edge of the female connector protective cover 26. The female connector protective cover 26 may be detachably connected to the top protective cover 4 via the plurality of connecting tabs 262.

As shown in FIG. 5, in some embodiments, one side of the female connector protective cover 26 may be exposed at a side surface of the battery cell body 3. The side of the female connector protective cover 26 may be flush with a sidewall of the top protective cover 4 at the side surface. When encountering rain or snow water, the water may flow downward along the sidewall of the top protective cover 4 and a sidewall of the female connector protective cover 26 and may not enter a mated portion of the female connector 9 and the male connector 8, thereby avoiding damage or failure of the female connector 9 and the male connector 8 due to water.

A slide groove 27 may be formed along the vertical direction on a side of the battery cell body 3 adjacent to the female connector protective cover 26. The female connector protective cover 26 may be disposed at a top portion of the slide groove 27. The battery cell body 3 may be configured to slide downward relative to the male connector 8 via the slide groove 27 along the vertical direction, thereby enabling rapid engagement of the male connector 8 with the female connector 9.

As shown in FIGS. 1, 2, and 6, in some embodiments, the battery compartment 2 may include a base 10, a front plate 11, a rear plate 12, a left plate 13, and a right plate 14. Each of the front plate, the rear plate, the left plate, and the right plate may be perpendicular to the base 10. The front plate 11, the rear plate 12, the left plate 13, and the right plate 14 may collectively define an accommodating cavity 33 shaped to receive the battery 1.

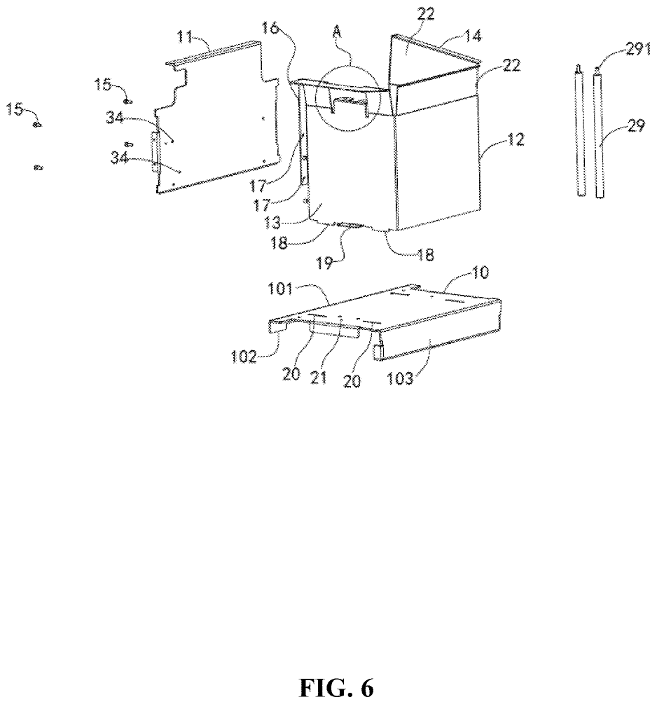

Further, in FIG. 6, the base 10 may include a bottom plate 101, a first support wall 102 and a second support wall 103. The first support wall 102 and the second support wall 103 may be disposed at a bottom portion of the bottom plate 101. The first support wall 102 and the second support wall 103 may be respectively located at front and rear sides of the bottom plate 101 and may be perpendicular to the bottom plate 101.

In some embodiments, the rear plate 12, the left plate 13, and the right plate 14 may be integrally formed to define a U-shaped structure. The front plate 11 may be detachably connected to the left plate 13 and to the right plate 14.

Specifically, one or more second through holes 34 may be provided at each of two sides of the front plate 11. A second connecting bolt 15 may be disposed through each of the plurality of second through holes 34. A connecting plate 16 may be provided at an edge of each of the left plate 13 and the right plate 14 adjacent to the front plate 11. Each connecting plate 16 may be parallel to the front plate 11. Each connecting plate 16 may extend in a direction away from the left plate 13 or the right plate 14. One or more second connecting holes 17 may be provided in each connecting plate 16, each second connecting hole 17 may correspond to a respective one of the plurality of second through holes 34, and each second connecting bolt 15 may be configured to pass through the corresponding second connecting hole 17 and to engage with a nut, such that the front plate 11 may be secured to the left plate 13 and to the right plate 14.

In some embodiments, upper portions of the rear plate 12, the left plate 13, and the right plate 14 may be inclined slightly outwardly to form expanded portions 22. The plurality of expanded portions 22 may collectively define a tapered structure that may be wider at a top and narrower at a bottom, which may facilitate the insertion of the battery 1 into the battery compartment 2 from the top portion thereof.

In some embodiments, protruding positioning blocks 18 may be disposed at bottom portions of the left plate 13 and the right plate 14, respectively. The base 10 may be provided with positioning holes 20 configured to receive the positioning blocks 18. The positioning blocks 18 may be configured to be inserted into the positioning holes 20. The positioning holes 20 may be provided in the bottom plate 101 of the base 10. The bottom portions of the left plate 13 and the right plate 14 may be configured to be inserted into the corresponding positioning holes 20 via the positioning blocks 18 to achieve pre-positioning of the left plate 13 and the right plate 14.

Further, fixing tabs 19 may be respectively disposed at the bottom portions of the left plate 13 and the right plate 14. The fixing tabs 19 may be perpendicular to the positioning blocks 18 and extend away from the battery compartment 2. One or more third through holes (not shown) may be provided in each of the fixing tabs 19. A third connecting bolt 31 may be disposed through each of the plurality of third through holes. A plurality of third connecting holes 21 corresponding to the plurality of third through holes may be disposed in the base 10. Each of the plurality of third connecting bolts 31 may be configured to pass through a corresponding one of the plurality of third connecting holes 21 and to engage with a nut, such that the fixing tabs may be secured to the base 10. In this way, the left plate 13 and the right plate 14 may be fixed to the base 10.

In some embodiments, the bottom portion of each of the left plate 13 and the right plate 14 may be provided with two positioning blocks 18 and one fixing tab 19. The fixing tab 19 may be located between the two positioning blocks 18.

As shown in FIG. 6, in some embodiments, a connecting bracket 25 may be disposed at a top portion of the battery compartment 2. A bracket base 28 may be fixedly connected to the connecting bracket 25. The bracket base 28 may be provided with the male connector 8 configured to mate with the female connector 9. When the battery 1 is installed in the battery compartment 2, the male connector 8 may engage with the female connector 9.

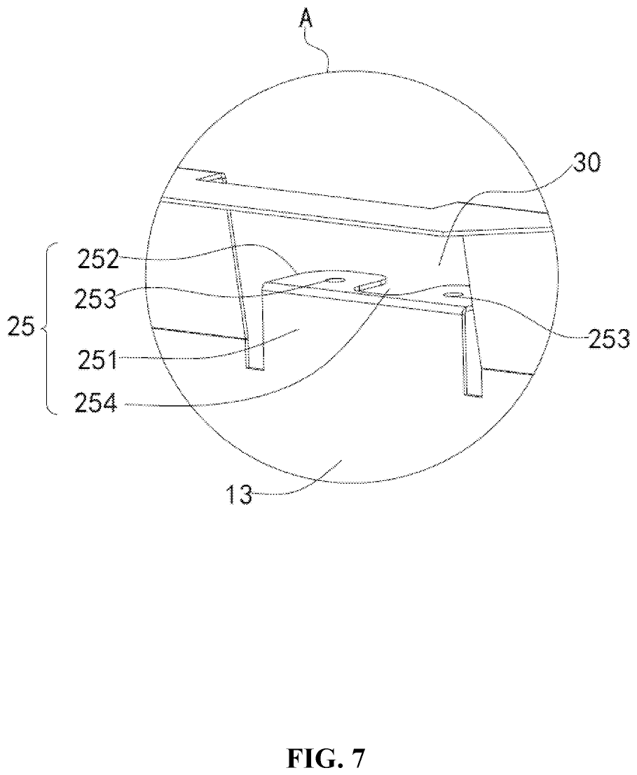

As shown in FIGS. 6 and 7, in some embodiments, the connecting bracket 25 may be disposed on the left plate 13. The connecting bracket 25 may be adjacent to the expanded portion 22 of the left plate 13. The expanded portion 22 of the left plate 13 may be provided with a clearance hole 30. The clearance hole 30 may provide a clearance space for the connecting bracket 25 to prevent the expanded portion 22 and the connecting bracket 25 from interfering with each other.

In some embodiments, the connecting bracket 25 may have an inverted L-shape. The connecting bracket 25 may include a vertical bracket sidewall 251 and a horizontal bracket sidewall 252. The vertical bracket sidewall 251 may be integrally connected to the left plate 13. The horizontal bracket sidewall 252 may be perpendicular to the left plate 13. The horizontal bracket sidewall 252 may extend toward the right plate 14. The horizontal bracket sidewall 252 may be provided with one or more bracket through holes 253. The bracket through holes 253 may be configured to receive the bracket base 28. A wire passing groove 254 may be disposed at a middle portion of the horizontal bracket sidewall 252. A cable at a bottom portion of the male connector 8 may pass through the wire passing groove 254.

The bracket base 28 may have a generally L-shape. The bracket base 28 may include a vertical support sidewall 281 and a horizontal support sidewall 282. The vertical support sidewall 281 may be parallel to the vertical bracket sidewall 251. The horizontal support sidewall 282 may be parallel to the horizontal bracket sidewall 252. The male connector 8 may be detachably connected to the vertical support sidewall 281. The horizontal support sidewall 282 may be positioned above the horizontal bracket sidewall 252. Support connecting holes (not shown) corresponding to the bracket through holes 253 may be provided at a bottom portion of the horizontal support sidewall 282. Vertical support posts 29 may be disposed within the battery compartment 2. Each vertical support post 29 may provide a supporting force to the connecting bracket 25 on the one hand, and may also be configured to connect with the bracket base 28 on the other hand. Specifically, a connecting post 291 may be disposed at a top portion of each vertical support post 29. The connecting post 291 may be configured to extend through the corresponding bracket through hole 253 and to threadedly engage the horizontal support sidewall 282 at the corresponding support connecting hole, such that the bracket base 28 may be secured to the vertical support post 29.

In some embodiments, at least two vertical support posts 29 may be provided. Bottom portions of the vertical support posts 29 may be detachably connected to the base 10.

The present disclosure also discloses a snow-clearing robot having the above-mentioned battery assembly. When the snow-clearing robot encounters a deep snow water environment, since the male connector 8 is disposed at the top portion of the battery compartment 2 and the female connector 9 is disposed at the top portion of the battery 1, the vertical height where the mated portion of the connector 8 and the female connector 9 is located may be relatively high, and snow water may not enter the male connector 8 and the female connector 9, thereby avoiding damage to the male connector 8 and the female connector 9. In addition, the provision of the female connector protective cover 26 may also play a protective role on the female connector 9 to prevent snow water, sand, dust, etc. from entering the female connector 9 and causing the female connector 9 to be damaged or fail.

The technical features of the embodiments described above can be combined in any manner. To make the description concise, not all possible combinations of the technical features in the above-mentioned embodiments have been described. However, as long as there is no contradiction in the combination of these technical features, they should all be considered within the scope described in this specification.

The above-mentioned embodiments only express several implementation modes of the present disclosure, and their description is relatively specific and detailed, but should not be understood as a limitation on the scope of the present disclosure. It should be pointed out that for those of ordinary skill in the art, several variations and improvements can be made without departing from the concept of the present disclosure, and these all fall within the protection scope of the present patent document.

1. A battery assembly, comprising:
a battery comprising a battery cell body and a female connector operably connected to the battery cell body, wherein:
the female connector includes a mating face oriented in a downward direction, and
the female connector is configured to serve as both a charging interface and a discharging interface for the battery cell body; and
a battery compartment having an open end and shaped to removably receive the battery via the open end, wherein:
the battery compartment is provided with a male connector, the male connector having a mating face oriented in an upward direction, and
the male connector is configured to engage the female connector by the mating face of the male connector engaging the mating face of the female connector when the battery is installed in the battery compartment.

2. The battery assembly according to claim 1, wherein:
a female connector protective cover is disposed around a periphery of the female connector, the female connector protective cover has a generally plate-shaped structure and defines a female connector fixing cavity extending therethrough in a vertical direction;
the female connector is configured to be inserted into the female connector fixing cavity; and
a bottom surface of the female connector is flush with, or slightly above, a lower edge of an inner surface of the female connector fixing cavity.

3. The battery assembly according to claim 2, wherein:
a plurality of connecting tabs are disposed circumferentially along an edge of the female connector protective cover; and
the battery assembly comprise s a top protective cover disposed at a top portion of the battery cell body, the top protective cover being detachably connected to the battery cell body, the top protective cover being configured to cover top portions of the female connector and the female connector protective cover, and the female connector protective cover being detachably connected to the top protective cover via the plurality of connecting tabs.

4. (canceled)

5. The battery assembly according to claim 3 comprising a female connector circuit board disposed between the top protective cover and the female connector, wherein:
the female connector is fixed below the female connector circuit board and is electrically coupled to the female connector circuit board
a top portion of the top protective cover defines a first groove recessed downward; and
a space between a sidewall defining the first groove and a sidewall of the top protective cover forms an installation cavity, the female connector circuit board being disposed within the installation cavity.

6. (canceled)

7. (canceled)

8. (canceled)

9. The battery assembly according to claim 2, wherein a slide groove is formed along the vertical direction on a side of the battery cell body where the female connector protective cover is disposed, and the battery cell body is configured to slide up and down in the vertical direction relative to the male connector via the slide groove.

10. The battery assembly according to claim 2, comprising a bottom protective cover disposed at a bottom portion of the battery cell body, wherein the battery cell body is detachably connected to the bottom protective cover.

11. The battery assembly according to claim 1, wherein the battery comprises a top protective cover disposed at a top portion of the battery cell body and detachably connected to the battery cell body, and the top protective cover is configured to cover a top portion of the female connector.

12. (canceled)

13. The battery assembly according to claim 1, wherein the battery compartment comprises a base, a front plate, a rear plate, a left plate, and a right plate, each of the front plate, the rear plate, the left plate, and the right plate being perpendicular to the base, and the front plate, the rear plate, the left plate, and the right plate collectively defining an accommodating cavity shaped to receive the battery.

14. (canceled)

15. (canceled)

16. (canceled)

17. The battery assembly according to claim 13, wherein upper portions of the rear plate, the left plate, and the right plate are inclined outwardly to form expanded portions, and the expanded portions collectively define a tapered structure that is wider at a top and narrower at a bottom.

18. (canceled)

19. The battery assembly according to claim 11 wherein:
a female connector protective cover is disposed around a periphery of the female connector;
one side of the female connector protective cover is exposed at a side surface of the battery cell body; and
the side of the female connector protective cover is flush with a sidewall of the top protective cover at the side surface.

20. The battery assembly according to claim 1, wherein a connecting bracket is disposed at a top portion of the battery compartment, a bracket base is fixedly connected to the connecting bracket, and the male connector is disposed on the bracket base.

21. The battery assembly according to claim 20, wherein:
the connecting bracket has an inverted L-shape and comprises a vertical bracket sidewall and a horizontal bracket sidewall; and
a bracket through hole is provided in the horizontal bracket sidewall and is configured to receive the bracket base.

22. The battery assembly according to claim 21, wherein:
the bracket base has a generally L-shape and comprises a vertical support sidewall and a horizontal support sidewall, the vertical support sidewall is parallel to the vertical bracket sidewall, the horizontal support sidewall is parallel to the horizontal bracket sidewall, and the male connector is detachably connected to the vertical support sidewall;
the horizontal support sidewall is positioned above the horizontal bracket sidewall, and a support connecting hole is provided at a bottom portion of the horizontal support sidewall, the support connecting hole corresponding to the bracket through hole; and
a vertical support post is disposed within the battery compartment, a connecting post is disposed at a top portion of the vertical support post, and the connecting post is configured to extend through the bracket through hole and to threadedly engage the horizontal support sidewall at the support connecting hole, such that the bracket base is secured to the vertical support post.

23-28. (canceled)

29. A snow-clearing robot, comprising the battery assembly according to claim 1.

30. The battery assembly according to claim 1, wherein the female connector is a sole external electrical interface of the battery, the female connector being configured to serve as both the charging interface for engagement with a charging connector external to the battery compartment when the battery is removed from the battery compartment, and the discharging interface for engagement with the male connector when the battery is installed in the battery compartment.

31. The battery assembly according to claim 30, wherein the mating face of the female connector is configured to serve as both the charging interface and the discharging interface, the mating face engaging the charging connector when the battery is removed from the battery compartment and engaging the male connector when the battery is installed in the battery compartment.

32. The battery assembly according to claim 20, wherein the male connector and the female connector, when engaged with each other, are positioned at an upper portion of the battery compartment such that liquid entering the battery compartment from the open end is inhibited from reaching the engagement between the male connector and the female connector.

33. The battery assembly according to claim 1, wherein the battery is configured to be removed from the battery compartment to disengage the female connector from the male connector, and the female connector of the removed battery is configured to be engaged with a charging connector external to the battery compartment to receive charging power for the battery cell body.

34. A method of operating a snow-clearing robot, the method comprising:
providing a battery assembly comprising:
a battery comprising a battery cell body and a female connector operably connected to the battery cell body, the female connector including a mating face oriented in a downward direction and configured to serve as both a charging interface and a discharging interface for the battery cell body, and
a battery compartment of the snow-clearing robot, the battery compartment having an open end and being provided with a male connector having a mating face oriented in an upward direction;
inserting the battery into the battery compartment via the open end, the inserting causing the mating face of the male connector to engage the mating face of the female connector to establish a discharging connection;
removing the battery from the battery compartment, the removing disengaging the mating face of the male connector from the mating face of the female connector;
engaging the female connector of the removed battery with a charging connector external to the snow-clearing robot via the mating face of the female connector to establish a charging connection; and
after charging the battery cell body via the mating face of the female connector, reinserting the battery into the battery compartment to re-establish the discharging connection via the same mating face of the female connector that was used for the charging connection.

35. The method according to claim 34, wherein the inserting comprises aligning the battery via a slide groove on the battery cell body to guide the battery in a substantially vertical direction such that the mating face of the female connector engages the mating face of the male connector along a substantially vertical axis.
